(19) United States
(12) Patent Application Publication
(10) Pub. No.: US 2002/0113104 A1
(43) Pub. Date: Aug. 22, 2002

(54) Utensil scabbard

(75) Inventor: Clark A. Levsen, Shawnee, KS (US)

Correspondence Address: HOVEY, WILLIAMS, TIMMONS & COLLINS, Suite 400, 2405 Grand, Kansas City, MO, 64108, US

(73) Assignee: HANTOVER, INC.

(21) Appl. No.: 09/790,110

(22) Filed: Feb. 21, 2001

(51) Int. Cl. B26B 29/02; A45F 5/00

(52) U.S. Cl. 224/233; 224/232; 224/673; 224/249; 224/245

(57) ABSTRACT

A utensil scabbard (10) for holding knives or similar utensils is provided, including a rigid, walled housing (12) having a utensil-receiving section (52) supporting a utensil retainer (14). The retainer (14) includes a set of side-by-side web members (16) preferably held within the housing (12) by the rigid housing walls (22, 24, 26, 32), lips extending from the housing sidewalls, and inwardly extending tab members (38). The web members are separated laterally when a knife (40) is inserted into the utensil retainer (14), but resiliently and functionally engage the blade (44) of the inserted knife (40). The scabbard housing (12) further contains an attachment section (18) having attachment openings (20) for receiving a belt or chain (52). Additionally, the housing (12) includes a detachable wall (32) which can be slidably disengaged from lips (30) of the housing sidewalls (30), allowing easy disassembly and cleanup.

### BACKGROUND OF THE INVENTION

1. Field of the Invention

The present invention is broadly concerned with an improved utensil scabbard for knives, meat hooks, or other meat-packing industry utensils which will accommodate a variety of such utensils and permit easy cleanup and sanitation of both the utensils and the scabbard. The preferred utensil scabbard of the invention includes a housing and a utensil retainer located therein for frictional retention of the utensil. A further preferred embodiment of the scabbard provides for easy disassembly, cleaning and sanitation of the components. The scabbard is particularly useful in the meat-packing industry, by enhancing the sanitation and safety of the utensils.

2. Description of the Prior Art

A typical sword scabbard includes a rigid material, usually metal, in which the blade is inserted. These scabbards use gravity and the weight of the sword to hold the weapon in its place. A piece of string or leather is tied around the upper part of the scabbard and then to the user for attachment purposes. Scabbards are also well-known for use in holding knives and daggers. These scabbards are usually made of leather, leaving a narrow opening for insertion of the blade. They often have a small piece of leather around the upper part of the handle and employing a snap or tie to secure the weapon within the scabbard. These scabbards are often attached to the user by threading a belt through openings in the leather or by string attachment means. In the meat-packing industry, utensil scabbards are used; these are generally made of leather and typically do not have securement straps or the like, inasmuch as these expedients tend to interfere with frequent utensil use. While this does permit ready utensil use, it can be dangerous if a scabbard containing a utensil is carelessly handled; indeed, accidents have occurred when a scabbard with a knife therein is dropped or thrown, because the knife can so readily disengage from the scabbard. These prior utensil scabbards are also difficult to clean because of the materials used and the inability to access the interior of the scabbard, a definite disadvantage in an industry where sanitation is paramount.

### SUMMARY OF THE INVENTION

The present invention overcomes the prior art problems and provides an effective, inexpensive utensil scabbard that is easy to disassemble and clean. Furthermore, the scabbard improves safety by frictionally engaging utensils within the scabbard, preventing injury owing to accidental release. At the same time, the utensils can be quickly and easily removed and replaced in the scabbard by a user.

The utensil scabbard preferably comprises an upright, rectangular in cross section body having a housing and a utensil-receiving section. The housing is preferably formed of metal, but any suitable material maybe used. The housing has two sections: an upper, generally flat section having attachment openings for receiving a belt or chain, to allow attachment of the scabbard to the user, and a second, lower utensil-receiving section. The utensil-receiving section contains a utensil retainer presenting an utensil-insertion opening allowing placement of utensils. Additional openings in the housing walls, preferably in the sidewalls, facilitate storage of non-blade utensils such as meat hooks. Preferably, the housing has a detachable wall that can be slidably engaged within the fixed housing sidewalls. The preferred utensil retainer is located within the housing walls and includes a series of web members, each formed of a resilient synthetic resin material and of generally V-shaped configuration in cross-section, presenting an elongated bight and a pair of diverging leg sections. The web members are placed in juxtaposition so that at least the lower ends thereof are in contact with each other, prior to insertion of a utensil into the scabbard. In order to retain the web members within the housing in side-by-side alignment, the housing sidewalls and the detachable wall have inwardly facing lips. The detachable wall front may be angled on its lower end to contact the rear wall of the housing.

In use, a knife or other utensil is slid downwardly between adjacent web members and is retained therein by virtue of the compressive forces exerted against the knife. meat hooks or other non-blade utensils are inserted into small openings sized specifically for receipt of such utensils. The scabbard is preferably sized to accommodate implements of varying widths and lengths, and maybe readily disassembled for cleaning purposes.

### BRIEF DESCRIPTION OF THE DRAWINGS

FIG. 1 is a perspective view of the apparatus embodying this invention and showing the apparatus in fully assembled form without utensil engagement.

FIG. 2 is a fragmentary perspective view of the apparatus, depicting the apparatus without one side wall and a portion of a detachable wall of the housing. The view shows a cut-away and a whole perspective of side-by-side web members with utensil engagement.

FIG. 3 is a vertical cross-sectional side view of the apparatus, depicting the relation of the housing, the web members, the tab members, and a knife during use of the apparatus.

FIG. 4 is an exploded partial view of the apparatus, depicting the side-by-side web members supported by the tab members in the detachable housing wall in separable relation.

FIG. 5 is a fragmentary perspective view depicting the upper attachment section of the apparatus and the attachment openings, with a belt being threadably received by the openings.

### DETAILED DESCRIPTION OF THE PREFERRED EMBODIMENT

Turning now to the drawings, a utensil scabbard 10 is illustrated broadly including a housing 12 and utensil retainer 14 preferably made up of web members located within the housing. The housing also has an attachment section 18 having attachment openings 20.

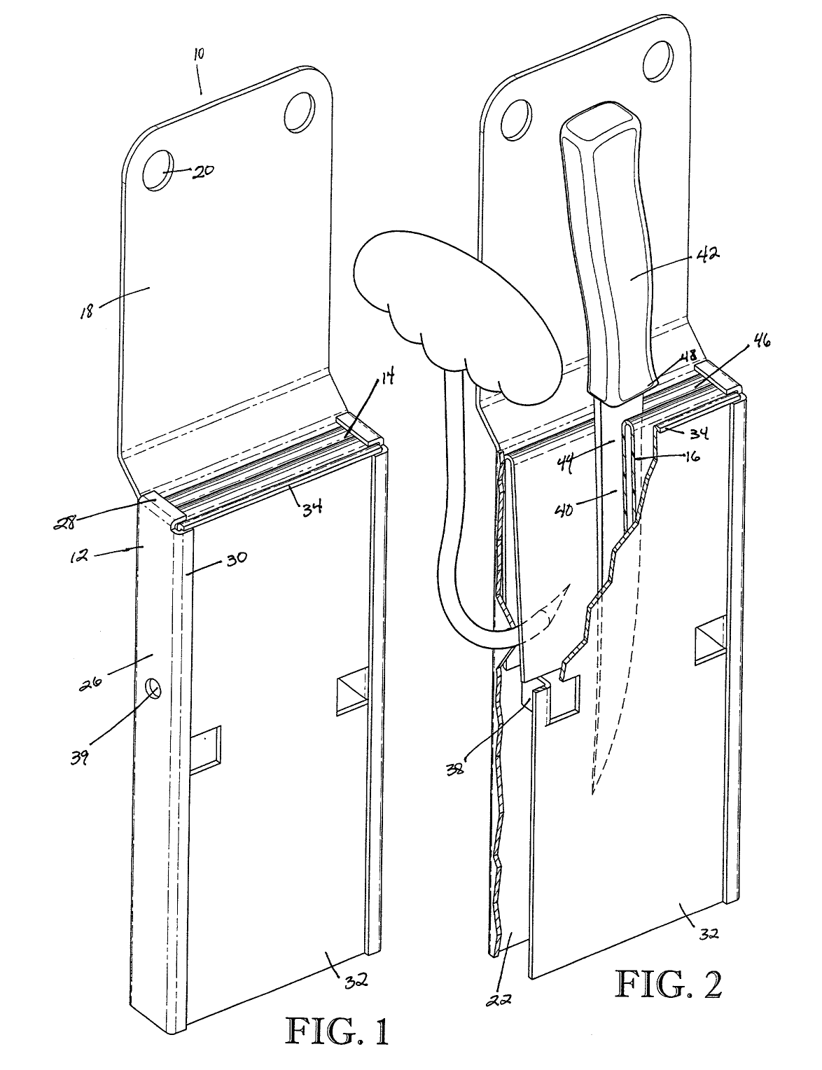

In more detail, the housing 12, as depicted in FIGS. 1-3, is in the form of an elongated, upright body, presenting an upper attachment section 18 having attachment openings 20, and a lower utensil-receiving section 52 preferably presenting a rear wall 22 extending downwardly from the upper attachment section 18, two marginal sidewalls 24, 26, each having a respective lip 28 extending inwardly and parallel to the rear wall 22, as well as lips 30 extending inwardly and perpendicular to the rear wall 22. The housing 12 further has a detachable wall 32 slidably engaged within the lip sections 28 parallel to the rear wall 22. The detachable wall 32 has an upper lip section 34 which engages and prevents downward movement within the housing. The detachable wall 32 may be inclined towards the rear wall 22 to further compress and support the individual web members 16. The walls of the housing 12, preferably the detachable wall 32, includes inwardly extending tab members 38 which support the web members 16. The walls of the housing 12, preferably the sidewalls 24, 26 contain additional non-blade utensil openings 39, as best depicted in FIGS. 1 and 2. The housing 12 may be formed of a variety of materials such as metal or synthetic resin.

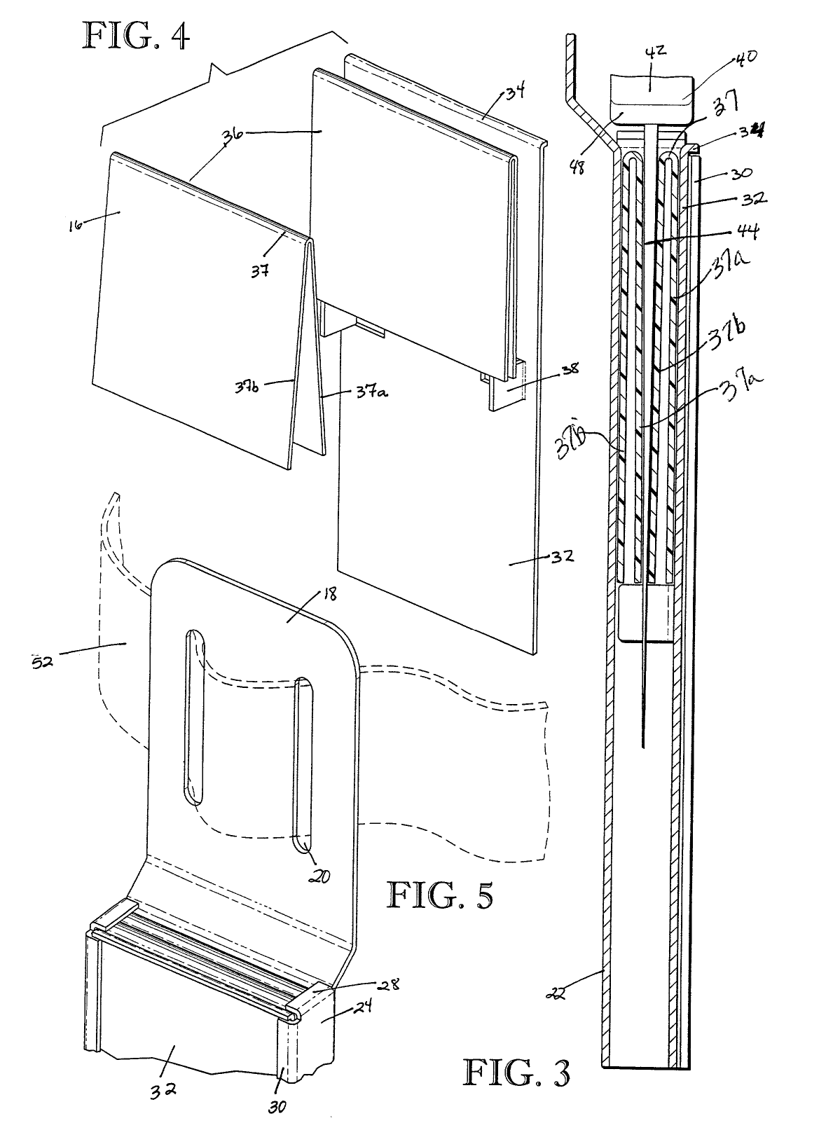

The retainer 14 is located within the housing walls 22,24,26, and 32, as best depicted in FIG. 3 and comprises web members 16 oriented to present a web member set 36. The set 36 includes a plurality of essentially identical juxtaposed web members 16, but the set preferably has two such web members. Each member is formed of resilient synthetic resin material and has an upper bight 27 and a pair of depending legs 37a,37b. Referring to FIG. 4, it will be observed that the placement of such web members 16 in side-by-side relationship to form the web member set 36 will, in cross section, present a generally V-shape configuration. As best illustrated by FIG. 3, the individual web members 16 are placed in side-by-side relationship to form the set 36, with at least the legs 37a, 37b of the respective members in close adjacency in engagement.

The web members 16 are held in the retainer 14 between cooperating sections including sidewall lips 30, sidewalls 24, 26, rear wall 22, and detachable front wall 32. The web members 16 are further retained by upper sidewall lips 28, upper detachable wall lips 34, and tab members 38. Thus, the web members 16 are restrained from upward or downward movement within the confines of the housing 12, but the legs thereof may shift slightly laterally as required to accommodate utensils. Also, a utensil insertion opening 46 is defined between adjacent web members 16.

In the use of the scabbard 10, the web members 16 are first placed within the fixed portions of the housing 12. The detachable wall 32 is then slidably moved within the lips 30 of the sidewalls 24 and 26 until the detachable wall lip 34 engages sidewall lips 30, as depicted in FIGS. 1 and 3. The scabbard is then ready to accept utensils such as knives 40. As depicted in FIG. 2, an exemplar knife includes an enlarged handle 42 and a blade 44. The knife is slid downwardly by inserting the knife, blade first, within an entrance opening 46 of the retainer until the base of the handle 48 engages the bights 37 of the web members 16. This causes the adjacent web members to separate laterally to accommodate the blade 44. The flexible yet resilient nature of the web members 16 allows receipt of the blade 44 while supplying a compressive functional force against the blade 44, holding the knife 40 within the retainer 14. However, the knife 40 is easily removable from the retainer 14 with a vertical pull by the user.

It will be appreciated that the retainer 14, while preferably containing two web members 16 formed of a flexible yet resilient synthetic resin, can also include differently configured frictional devices, such as additional or differently configured web members or web members constructed from nonresilient materials combined with biasing means to give the desired utensil-holding compressive force.

The scabbard 10 can be easily disassembled for cleanup and sterilization and quickly reassembled afterward. This is accomplished by sliding and detaching the front housing wall 32 out of engagement with the remainder of the housing walls and web members 16. Preferably, all components of the scabbard 10 are formed of materials which are easily washed and sterilized, such as metal or synthetic resins.

I claim:

1. A utensil scabbard comprising:
a housing presenting a lower utensil-receiving section and an upper attachment section adapted to be mounted on a user's clothing,
said housing having walls defining a utensil insertion and removal opening; and
a utensil retainer located within said housing and operable to frictionally engage and hold a utensil inserted into said utensil-receiving section through said opening, said retainer holding said utensil within the utensil-receiving opening when the scabbard is mounted on the user's clothing by exerting a compressive force on the utensil within the utensil-receiving section.

2. The scabbard of claim 1, said retainer being capable of holding said utensil within the utensil-receiving opening when the scabbard is inverted.

3. The scabbard of claim 1, said retainer including a plurality of side-by-side web members each having an entrance end and a remote end, there being a utensil-receiving opening between adjacent ones of said web members for receiving therein utensil portions, said web members configured to exert a compressive retaining force against said utensil portions within said openings.

4. The scabbard of claim 3, said retainer including two side-by-side web members.

5. The scabbard of claim 1, said housing having tab members comprising portions of at least one wall oriented so that said tab members provide a surface supporting said interior components.

6. The scabbard of claim 1, said upper attachment section having an upper end and having attachment openings proximal to said upper end for attachment to a belt or chain.

7. The scabbard of claim 1, said housing having sidewalls and at least one opening in said sidewalls configured for receipt of a meat hook.

8. A utensil scabbard comprising:
a housing presenting a lower utensil-receiving section and an upper attachment section adapted to be mounted on a user's clothing,
said housing having walls defining a utensil insertion and removal opening; and
a utensil retainer located within said housing and operable to frictionally engage and hold a utensil inserted into said utensil-receiving section through said opening, at least one of said housing walls being detachable from the remainder of the housing walls in order to permit removal of said utensil retainer and to permit cleaning of the scabbard.

9. The scabbard of claim 8, said retainer being capable of holding said utensil within the utensil-receiving opening when the scabbard is inverted.

10. The scabbard of claim 8, said retainer including a plurality of side-by-side web members each having an entrance end and a remote end, there being a utensil-receiving opening between adjacent ones of said web members for receiving therein utensil portions, said web members configured to exert a compressive retaining force against said utensil portions within said openings.

11. The scabbard of claim 10, said retainer including two side-by-side web members.

12. The scabbard of claim 8, said housing having tab members comprising depressed portions of at least one wall oriented so that said tab members provide a surface supporting said interior components.

13. The scabbard of claim 12, said tab members contained in the detachable housing wall.

14. The scabbard of claim 8, said upper attachment section having an upper end and having attachment openings proximal to said upper end for attachment to a belt or chain.

15. The scabbard of claim 8, said housing having a rear wall, said rear wall having an upper and lower end, and side walls adjacent said rear wall, said side walls having inwardly extending lips parallel to said rear wall to slidably receive said detachable housing wall.

16. The scabbard of claim 8, said housing having a rear wall, said rear wall having an upper and lower end, and side walls adjacent said rear wall, said side walls having an upper and lower end and having inwardly extending lips on the upper end of said side walls, perpendicular to said rear wall.

17. The scabbard of claim 15, said detachable housing wall having an upper end and a lower end, and an outwardly extending lip on said upper end.

18. The scabbard of claim 15, said detachable housing wall having an upper end and a lower end, said lower end angled to contact the lower end of said rear wall of the housing.

19. The scabbard of claim 8, said housing and utensil retainer components comprised of easily sanitizable materials.

20. The scabbard of claim 19, said materials comprised of metal and synthetic resin.

21. The scabbard of claim 8, said housing having sidewalls and at least one opening in said sidewalls configured for receipt of a meat hook.
